(19) United States
(12) Patent Application Publication
(10) Pub. No.: US 2021/0227749 A1
(43) Pub. Date: Jul. 29, 2021

(54) Rotary Implement for Harvester Combine Dispersal of Straw Cuttings

(71) Applicant: Super Spreader, L.L.C., Mott, SD (US)

(72) Inventors: Brent Kvasnicka, Peabody, KS (US); Chris Carlson, Mott, ND (US)

(73) Assignee: Super Spreader, L.L.C., Mott, SD (US)

(21) Appl. No.: 17/229,103

(22) Filed: Apr. 13, 2021

Related U.S. Application Data
(60) Provisional application No. 63/009,700, filed on Apr. 14, 2020.

(51) Int. Cl. A01D 41/12

(52) U.S. Cl. CPC A01D 41/1243

(57) ABSTRACT

A rotary implement for harvester combine dispersal of plant cuttings, the implement incorporating a base plate; a drive shaft connected to the base plate; a first plurality of channel and passage port combinations extending from the base plate to an elevation, the first combinations including channels underlying passage port lower ends; a second plurality of channel passage port combinations extending radially outwardly from a radially outer end of one of combinations among the first plurality of channel and passage port combinations, the second combinations having a channel upper walls sloping upwardly from passage port lower ends to the elevation; and a plurality of radially outer channels extending radially outwardly from second combinations.

### CLAIM OF PRIORITY FROM PREVIOUSLY FILED PROVISIONAL PATENT APPLICATION

This non-provisional patent application claims the benefit of and priority from U.S. Provisional Patent Application No. 63/009700 filed Apr. 14, 2020. The inventors and applicant disclosed in said provisional application are the same persons as the persons who are disclosed as the inventors in and applicant of the instant application. The applicant asserts that structures and functions of structures disclosed and described in the instant application are substantially identical to those disclosed in said provisional application.

### FIELD OF THE INVENTION

This invention relates to implements which are attachable to harvester combines or are thereby operable. More particularly, this invention relates to such implements which are adapted for rotary implement actuated dispersion of harvested plant waste materials such as cut straw, such dispersion being directed rearwardly from a harvester combine.

### BACKGROUND OF THE INVENTION

Harvester combines commonly include rear discharge ports for dispersion and ejection of harvested plant waste such as cut chaff and cut straw. Such waste materials are mechanically separated by the combine from a product of a crop, such as wheat heads and kernels. Separated cut straw is commonly rearwardly ejected from the harvester combine at a discharge port positioned at one of the harvester's lateral sides.

Rotary straw dispersing or throwing implements having a radial array of vanes or paddles are commonly mounted at the rear of a harvester combine, immediately below the combine's rear cut straw discharge port. Such rotary dispersing elements are commonly rotatably powered by a hydraulic motor.

Rotary dispersing implements of the type described above commonly fail to evenly disperse the discharged cut straw over the ground at the rear of the harvester combine, undesirably leaving bare areas or areas of excessively piled straw cuttings.

The instant inventive rotary implement for harvester combine dispersal of straw cuttings provides an improved cut straw dispersing rotary implement which incorporates and provides multiple passage port and channel combinations which are arranged in a radial array about a rotation axis, such combinations including specialized structural features for enhanced throwing trajectories for enhanced dispersion of the cut straw.

### BRIEF SUMMARY OF THE INVENTION

A first structural component of the instant inventive rotary implement for harvester combine dispersal of straw comprises a base plate having a central rotation point. In the preferred embodiment, the base plate is substantially circular and is composed of rigid sheet steel or sheet aluminum.

A further structural component of the instant inventive rotary implement comprises a drive shaft which is connected operatively to the base plate, the drive shaft being normally aligned, and extending upwardly from or downwardly from the central point of the base plate. In a preferred embodiment, the end of the drive shaft which is not attached to the base plate is mounted to the rear of a harvester combine, there receiving rotary driving power from a motor mounted operatively at the rear of the combine. In a preferred embodiment, the motor constitutes an hydraulic motor.

Further structural components of the instant inventive rotary implement comprise a first plurality of channel and passage port combinations, hereinafter referred to as “first combinations”. In a suitable embodiment, four of such channel and passage port combinations are included in the first combinations. The first combinations being evenly spaced in a 90° increment radial array upon the base plate. Each first combination preferably extends upwardly from the base plate, and the channel component of each first combination preferably has a radially inner end, a radially outer end, an upper end, and a lower end. Each first combination's channel component preferably further has a lower wall which may suitably function as a mounting flange, such channel component further having a vertical web and a substantially horizontally extending upper wall.

The passage port component of each combination among the first combinations preferably constitutes an open space for rearward passage of cut straw, such space extending upwardly from said each combination's underlying channel to an upper elevation.

Further structural components of the instant inventive rotary implement comprise a second plurality of channel and passage port combinations, which are hereinafter referred to as “second combinations”. The number of the second combinations is preferably equal to that of the first combinations, each combination among the second combinations similarly extending upwardly from the base plate. The channel component of each combination among the second combinations preferably has a radially inner end which abuts and communicates with the radially outer end of one of the first combinations' channels. In a suitable embodiment, such abutting channel ends may be fused or formed wholly with each other. Like the first combinations' channel components, each of the second combinations' channel components has a lower wall which may be suitably configured as a plate mounting flange. Said each channel also has an upper wall which necessarily extends along an upward slope from such channel's radially inner end.

Similarly with the first combinations' passage ports, the passage port component of each combination among the second combinations extends upwardly from said each combination's underlying channel, such extensions preferably terminating at the vertical elevation which is substantially equal to those of the upper ends of the first combinations' passage ports. While the first combinations' passage ports are preferably rectangular or square, each of the second combinations' passage ports is preferably triangular, the lower end of said each passage port being bounded and defined by an upwardly sloping upper wall of an underlying channel component. Each of the upwardly sloping upper walls of the second combinations' channel components preferably extends substantially perpendicularly or horizontally from its channel web portion.

Further structural components of the instant inventive rotary implement comprise a plurality of radially outer channels. Similarly with the implement's other channel components, each radially outer channel preferably extends vertically upwardly from the base. Similarly, with the second channels' matching relationship with the first channels, the number of the radially outer channels is preferably equal to that of the second channels.

In the preferred embodiment, the radially inner end of each channel among the radially outer channels abuts and communicates with the radially outer end of one of the second combinations' channels, such abutting communication suitably constituting fused or wholly formed channel junctures or joints. Each radially outer channel preferably further has an upper wall which is upwardly angled, the distal end of each such upwardly angled wall preferably residing at an elevation substantially equal to the common upper elevations of the rotary implement's multiple passage ports.

The instant inventive rotary implement is preferably rotatably mounted and rotatably driven at the rear of a harvester combine immediately below its cut straw discharge port. Cut straw emitting from such port and may fall rearwardly and downwardly toward the rotary implement while such implement rotates. As the cut straw passes downwardly and rearwardly, portions of the cut straw may advantageously pass through the first and second combinations' passage ports as such ports rotate. Thereafter, the cut straw may continue to fall downwardly onto the base plate to collect thereon immediately rearwardly from a radially aligned pair of channels among the first and second combinations' rotating channels.

Thereafter, portions of such cut straw immediately collect within those rotating channels, the straw being compressed therein by centrifugal force. Substantially simultaneously, the cut straw is centrifugally driven radially outwardly along the first and second combinations' aligned channels. Such radially outwardly moving straw reaches the expanded right trapezoidal space of the second combinations' channel, and the upwardly sloping upper wall of such channel advantageously facilitates a vertically directed release of the straw compression. Such straw compression release advantageously produces an upward movement of a portion of the collected straw along an upward angle which is directed by the sloping upper channel wall.

The upward movements of the cut straw guided by the upwardly sloping upper walls of the second combinations' channels advantageously continue as such cut straw radially outwardly enters the radially outer channels. The upwardly sloping upper walls of such radially outer channels are preferably upwardly angled for continued upward trajectory guidance of the upwardly moving cut straw.

The radially paired passage ports of the instant inventive implement, in combination with the upwardly sloping upper walls of the second combinations' channels advantageously enhance the implement's dispersion of cut straw at the rear of the harvester combine by facilitating upwardly angled throwing trajectories of portions of the cut straw.

Accordingly, objects of the instant invention include the provision of a rotary implement for harvester combine dispersal of straw cuttings which incorporates structures as described above, and which arranges those structures in manners described above for the performance of beneficial functions as described above.

Other and further objects, benefits, and advantages of the instant invention will become known to those skilled in the art upon review of the Detailed Description which follows, and upon review of the appended drawings.

### STATEMENT REGARDING CHARACTER OF DRAWINGS

The drawings submitted herewith are partially photographic in character. The Applicant admits that the subject matters of the drawings admit of illustration by drawings with the meaning of 37 C.F.R. 1.84(b) (1) and that, pursuant to that regulation, the Examiner has discretion to require a drawing in place of the photograph. Notwithstanding, the drawings are suitable for purposes of examination, and the Applicants request that any requirement for submission of replacement drawings be held in abeyance until examination is complete.

### BRIEF DESCRIPTION OF THE DRAWINGS

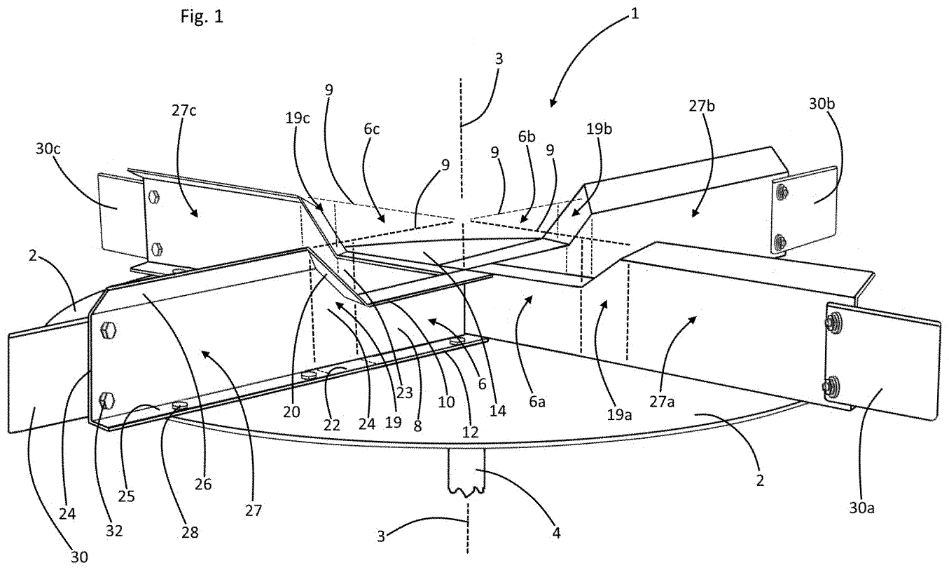

FIG. 1 is a perspective view of a suitable embodiment of the instant inventive rotary implement for harvester combine dispersal of straw cuttings.

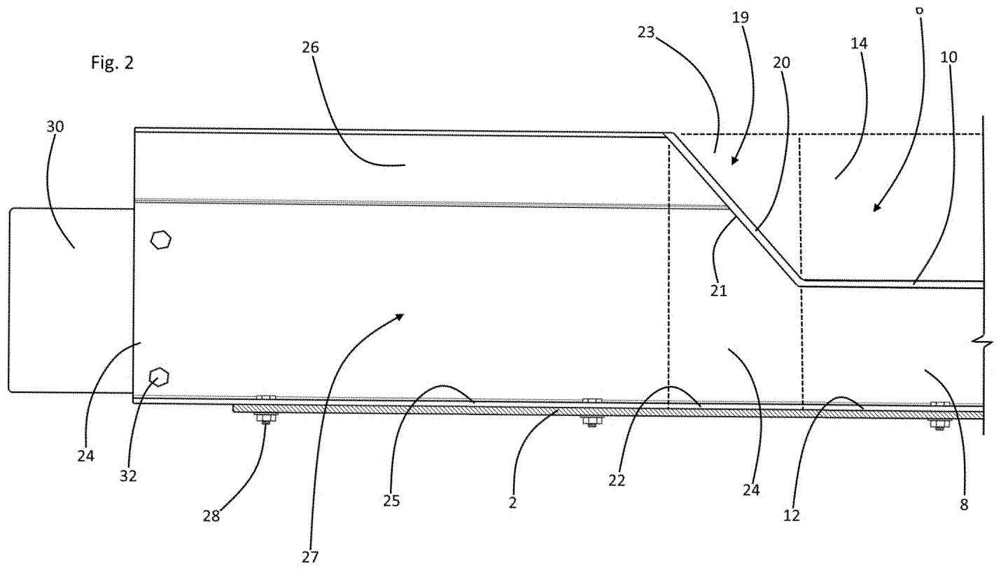

FIG. 2 is an alternative perspective view of a portion of the structure depicted in FIG. 1.

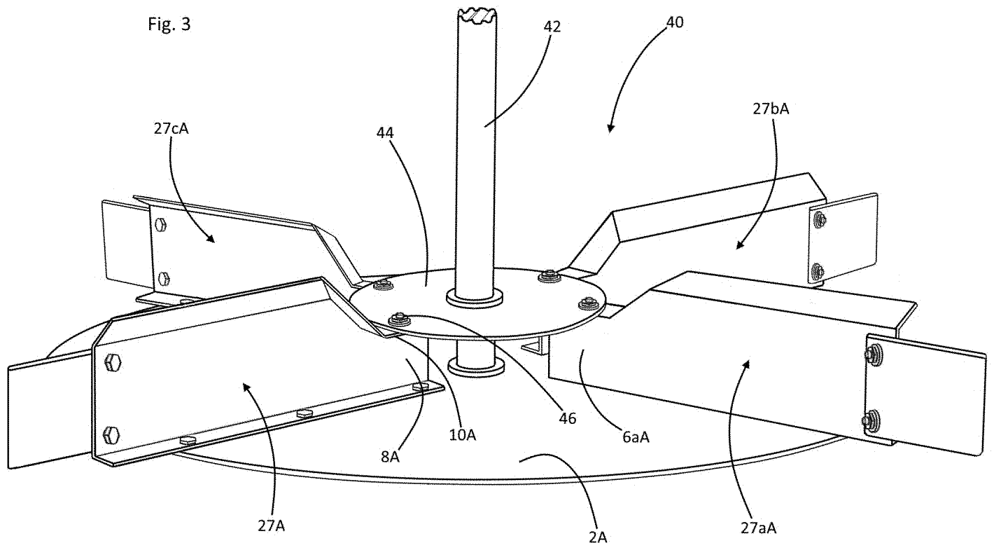

FIG. 3 redepicts the structure of FIG. 2, the view of FIG. 3 alternatively incorporating an upwardly extending drive axle.

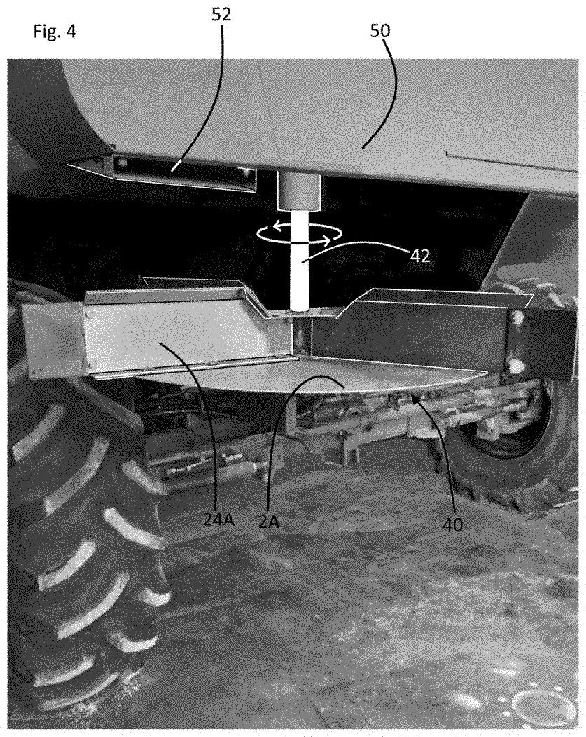

FIG. 4 redepicts the structure of FIG. 3, the view of FIG. 4 showing the FIG. 3 structure mounted upon the rear of a harvester combine.

### DETAILED DESCRIPTION OF PREFERRED EMBODIMENTS

Referring now to the drawings and in particular simultaneously to Drawing FIGS. 1 and 2, a preferred embodiment of the instant inventive rotary implement for harvester combine dispersal of straw cuttings is referring to generally by Reference Arrow 1. The implement 1 has a circular base plate 2 and has an axially and centrally aligned rotary drive shaft 4. In the alternative configuration depicted in FIG. 3, drive shaft 42 may alternatively mount to base plate 2A, and may extend upwardly therefrom. The base plate 2 and axle 4 of the FIG. 2 configuration rotates about vertical axis 3.

First structural components of the instant inventive implement 1 comprise a plurality of channel passage port combinations which are referred to by Reference Arrows 6, 6a, 6b, and 6c. Hereinafter, such channel and passage port combinations are referred to as “first combinations”. The first combinations 6, 6a, 6b, and 6c are preferably substantially identically configured.

The channel component of the channel and passage port combination 6 has a vertical web or wall 8, and has upper and lower walls 10 and 12. Suitably, the lower wall may comprise a portion of the upper surface of the base plate 2, and preferably, as depicted, the lower wall of such channel component is configured as a mounting flange. Bolts 28 may be used to secure such flange 12 to the plate 2. In the preferred embodiment, such channel's upper wall 10 extends perpendicularly from both the web 8 and the axis 3.

The passage port 14 component of the combination 6 preferably is downwardly bounded by wall 10, such port extending upwardly to an upper elevation 9. Radially outer boundaries of passage port 14 are indicated by a vertically drawn dashed line 15.

As is shown in FIG. 2, upper wall or flange 10 resides at an elevation above the base plate 2 which is between ⅓ and 1/12 of the vertical distance between base plate 2 and upper elevation 9.

A plurality of second channel and passage port combinations is referred generally by Reference Arrows 19, 19a, 19b, and 19c. Hereinafter, such combinations are referred to as “second combinations”. Each second combination's channel, for example the channel of combination 19, preferably comprises a vertically extending web 24, a mounting flange configured lower wall 22, and an upwardly sloping upper wall 20. The radially inner end of such channel 20,22,24 preferably is matchingly sized for abutting contact with the radially outer end of channel 8,10,12, those two channels preferably meeting at a wholly formed joint located at a drawn dashed line 13. In the preferred embodiment, the slope of such second channel's upper wall 20 extends upwardly at approximately 45°, such angle suitably being as shallow as 38° or as steep as 52°. In the preferred embodiment, the open space defined by the second channel's walls 20,22,24 is right trapezoidally shaped.

The passage port component 23 of such second combination 19 is preferably triangular, such port extending upwardly from upper wall 20 to the upper elevation 9. Second combinations 19a, 19b, and 19c are preferably configured substantially identically with second combination 19.

A plurality of radially outer channels are referred to generally by Reference Arrows 27, 27a, 27b, and 27c, each such channel having a radially inner end abutting and preferably wholly or integrally connecting to the radially outer end of one of the second channels. Each radially outer channel, channel 27 for the sake of example, has a lower mounting flange configured wall 25, a vertically extending web wall 24, and an angled upper wall 26. In a preferred embodiment, the angled upper wall 26 extends approximately 45° upwardly from horizontal. Suitably, the radially outer channels' upper wall angles may alternatively be as shallow 38° above horizontal or as steep as 52°. Each radially outer channel 27, 27a, 27b, and 27c has a vertical height substantially matching elevation 9. Flexible flaps 30, 30a, 30b, and 30c are preferably attached to the extreme radially outer ends of the radially outer channels by bolts 32, such flaps assisting in cut straw dispersion.

Referring simultaneously to FIGS. 1-3, each structure of Drawing FIG. 3 which is identified by a reference numeral having a suffix “A” is configured substantially identically to similarly numbered structures appearing in Drawing FIGS. 1 and 2. In FIG. 3, implement 40 has an upwardly extending axle 42 which rotatably drives plate 2A, such axle 42 being an alternative to the downwardly extending axle 4 of the FIG. 1 configuration. FIG. 3's alternate implement 40 enhances structural rigidity by providing an upper circular plate 44 which is mounted to upper channel wall surfaces by mounting bolts 46.

Referring simultaneously to FIGS. 3 and 4, the alternative rotary implement 40 may be advantageously mounted to the rear of a harvester combine 50, such combine having a rear cut straw ejection port 52. As shown in FIG. 4, the implement 40 rotates in the direction indicated by arrows drawn about drive shaft 42. Cut straw emitting from port 52 falls downwardly and rearwardly toward axle 42, toward plate 40, and toward other structures described above which are mounted for rotation upon the plate 2 or 2A, as the case may be.

Referring in particular to Drawing FIG. 2, such downwardly and forwardly falling cut straw may pass rearwardly (toward the viewer of FIG. 2) through passage ports 14 and 23. Thereafter, such straw lands upon the upper surface of plate 2 immediately to the rear of channels 8,10,12, and 20,22,24. As a result of the continuously rotating motion of the implement 1, portions of such cut straw which are ejected onto the plate 2 initially collect within the channel space which is defined by web 8 and walls 10 and 12. Such cut straw compresses therein due to the implement's rotary motion and centrifugal force. Substantially simultaneously such straw is thrown radially outwardly along the channel by the centrifugal force.

Such radially outward motion of the cut straw causes the straw to enter the right trapezoidal shaped channel space of combination 19, such space being defined by walls 20 and 22, and by web 24. Due to the increased interior volume of channel 20,22,24 in relation to its radially inwardly adjacent channel 8,10,12, the compression initially applied to the cut straw therein is partially released upon passage into channel 20,22,24. Such compression release advantageously results in upward expansion and upward motions of portions of such cut straw. The upwardly angled orientation of wall 20 further advantageously directs portions of such expanding straw mass along a substantially 45° upward trajectory.

Thereafter, the centrifugal force continues to drive the cut straw radially outwardly into the radially outer channel 27. The preferably 45° angled upper wall 26 then continues to angularly direct the cut straw upwardly for further inducing a straw throwing trajectory which enhances cut straw dispersion.

It may be seen that the angled upper wall 20 of the second channel and passage port combination 19 advantageously perform dual functions of downwardly defining passage port 23, and configuring the interior space of channel 20,22,24 as a right trapezoidal expansion space. Additionally, the angled undersurface 21 of wall 20 advantageously functions as a cut straw trajectory guiding element.

In rotary operation, the instant inventive implement 1 or 40, as the case may be, advantageously throws cut straw evenly and over a wide dispersion area to the rear of a harvester combine.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A rotary implement for harvester combine dispersal of plant cuttings, said implement comprising:
(a) a base plate;
(b) a drive shaft connected operatively to the base plate;
(c) a first plurality of channel and passage port combinations, each combination among the first plurality of channel and passage port combinations extending from the base plate to an elevation, said each combination comprising a channel underlying a passage port lower end;
(d) a second plurality of channel passage port combinations, each combination among the second plurality of channel and passage port combinations extending radially outwardly from a radially outer end of one of combinations among the first plurality of channel and passage port combinations, said each combination among the second plurality of channel and passage port combinations having a channel upper wall sloping upwardly from a passage port lower end to the elevation; and
(e) a plurality of radially outer channels, each channel among the plurality of radially outer channels extending radially outwardly from one of the combinations among the second plurality of channel and passage port combinations.

2. The rotary implement of claim 1 wherein said each channel among the plurality of radially outer channels comprises an upwardly sloping upper wall.

3. The rotary implement of claim 2 further comprising a plurality of mounting flanges, each flange among the plurality of mounting flanges being fixedly attached to the base plate.

4. The rotary implement of claim 3 wherein each channel among the plurality of radially outer channels comprises a lower wall, said lower wall comprising one of the mounting flanges.

5. The rotary implement of claim 4 wherein said each channel among the plurality of radially outer channels comprises an upwardly sloping upper wall.

6. The rotary implement of claim 5 wherein each combination among the second plurality of channel and passage port combinations comprises a channel having a trapezoidally shaped web.

7. The rotary implement of claim 6 wherein each combination among the second plurality of channel and passage port combinations comprises a triangularly shaped passage port.

8. The rotary implement of claim 1 wherein the upward slope from the passage port's lower end to the elevation is between 38° and 52°.

9.

9. The rotary implement of claim 5 wherein the upwardly sloping upper wall has a slope between 38° and 52°.

10. The rotary implement of claim 7 each combination among the first plurality of channel and passage port combinations comprises a rectangularly shaped passage port.

11. The rotary implement of claim 10 wherein the triangularly shaped passage port extends radially outwardly from the rectangularly shaped passage port.

12. The rotary implement of claim 1 wherein the drive shaft extends upwardly from the base plate.

13. The rotary implement of claim 12 wherein the first plurality of channel and passage port combinations comprises a quadruple of such combinations.

14. The rotary implement of claim 13 wherein the combinations among the first plurality of channel and passage port combinations are arrayed at 90° angular increments.

15. The rotary implement of claim 1 wherein each combination among the first and second pluralities of channel and passage port combinations has an upper end, wherein each channel among the radially outer channels has an upper end, and wherein all of said upper ends reside at the elevation.
